(19) United States
(12) Patent Application Publication
(10) Pub. No.: US 2018/0304104 A1
(43) Pub. Date: Oct. 25, 2018

(54) DESCENDER

(71) Applicant: CHECKMATE LIFTING & SAFETY LTD., Kent (GB)

(72) Inventors: Oliver AUSTON, Kent (GB); Christopher Joseph STOCKBRIDGE, Kent (GB)

(73) Assignee: CHECKMATE LIFTING & SAFETY LTD, Kent (GB)

(21) Appl. No.: 15/769,281

(22) PCT Filed: Oct. 21, 2016
(86) PCT No.: PCT/GB2016/053299

§ 371 Date: Apr. 18, 2018

(30) Foreign Application Priority Data
Oct. 23, 2015 (GB) 1518791.7

(51) Int. Cl. A62B 1/10; B66D 5/04; B66D 5/16; B66D 5/32

(52) U.S. Cl. CPC A62B 1/10; B66D 5/04; A62B 35/04; B66D 5/32; B66D 5/16

(57) ABSTRACT

A descender device for manually raising and lowering an object or person on a rope has a housing (which has opposing first and second ends and opposing side walls), an attachment means (provided at the first end of the housing and configured for attachment to an anchor point or to the object or person to be raised or lowered), rope entry and exit ports (at the second end of the housing), a drive pulley (around which the rope may be engaged), a centrifugal brake (configured to limit the speed of rotation of the drive pulley), a gear assembly, a wheel (arranged to be gripped by a user of the device), and a rope retaining means provided on an outside of the housing. The wheel is connected to the gear assembly. The rope retaining means comprises a projection and at least one groove.

### FIELD OF THE INVENTION

This invention relates to a descender device for permitting a person or object to safely descend or ascend a rope and to a method of using such a device. More particularly, this invention relates to a descender arranged to permit a person or object to descend a rope at a fixed speed or to ascend a rope.

### BACKGROUND OT THE INVENTION

Several devices, typically referred to as descenders, are known for manually lowering or raising an object or person along a rope. Descenders are often used as part of a safety system for people working at a height. A descender may, for example, be used as part of a fall arrest system or may be used in rescue equipment to enable a person to be lowered safely to the ground.

In particular constant rate descenders are known that comprise a pulley or drum around which a rope or safety line is passed. The pulley is connected to a centrifugal brake or brake which limits the speed of rotation of the pulley. The speed at which the rope is able to travel through the descender is, therefore, limited so that the person may be safely and slowly lowered.

These descenders may be used, for example, for an emergency evacuation with the descender being attached to an anchor point and a person being attached to one end of the rope. Alternatively, the descender may be used in an inverted configuration as a rescue device. In this situation the descender is attached to a rescuer and one end of the rope is attached to an anchor point. The rescuer will then descend to a casualty, manually lock the device, attach to the casualty and then continue the descent to safety.

The problem with known devices, however, is that it is difficult to lock the descender to halt the descent. It is, therefore, an object of the present invention to provide an improved descender device and method of using such a device when assembled with a rope.

### SUMMARY OF THE INVENTION

According to a first aspect of the present invention there is provided a descender device for manually raising and lowering an object or person on a rope, the device comprising:
a housing having opposing first and second ends and opposing side walls extending between the first and second ends;
attachment means at the first end of the housing, the attachment means being configured for attachment to an anchor point or to said object or person to be raised or lowered;
a rope entry port and a rope exit port in the second end of the housing;
a drive pulley around which said rope may be engaged;
a centrifugal brake configured to limit the speed of rotation of the drive pulley;
a gear assembly connecting the drive pulley to the centrifugal brake;
a wheel arranged to be gripped by a user of the device, the wheel being connected to the gear assembly; and
rope retaining means provided on an outside of the housing, said retaining means comprising a projection on at least one of said side walls of the housing and at least one groove in an external surface of the housing, said groove extending across said side wall corresponding with said projection, said projection being configured to redirect said rope from one of said ports when said rope is looped around said projection so that said rope is aligned to enter said groove on said side wall, the groove including gripping features for gripping a portion of said rope inside said groove.

Preferably the drive pulley, centrifugal brake and gear assembly are mounted within the housing. The centrifugal brake may be contained within a sealed chamber.

The inclusion of rope retaining means enables a user of the descender device to halt a descent and lock off the rope by engaging the rope with the retaining means. The retaining means holds or grips the rope, preventing the rope being drawn through the housing of the descender and thereby allows a user to release their grip of the rope and remain at a fixed point along the rope.

This advantage is achieved by the user wrapping the rope around the descender device so that the rope is engaged with the projection and the groove. In particular the user first loops the rope around the projection so that the rope changes direction, and then inserts a portion of the rope into the groove so that it is held by the gripping features.

Each port is preferably laterally adjacent a corresponding one of the side walls.

Each port may also be configured to orient a rope extending out of the port in a direction that turned towards the corresponding side wall, so that the rope may more readily be directed by hand towards that side wall.

The groove preferably extends around a corner between the side wall and the second end of the housing. This makes it easier to wrap the rope around the two opposite sides and second end of the housing.

A projection may be provided on both of the side walls, each of the projections being configured to redirect the rope from one of the ports when the rope is looped around the projection so that said rope is aligned to enter the groove.

Therefore, the ports, projections and grooves on the housing are most preferably arranged with mirror symmetry about a central plane of the housing so that a free end of the rope may be secured in the same manner regardless of which port the free end extends from.

In one embodiment of the invention, there are two of the grooves, one for each of the projections on both of the side walls.

In an alternative embodiment of the invention, there is one groove which extends across both side walls and the second end of the housing.

In preferred embodiments a projection is provided on both of the side walls. In these embodiments, after a user has inserted a portion of the length of the rope into the groove, the rope will then be passed around the projection on the other side of the descender device. This provides a further change in direction of the rope, increasing the frictional forces on the rope and preventing the rope from moving through the device. Looping the rope around this second projection also helps to maintain the rope within the, or each, groove.

The, or each, projection preferably comprises an arm portion that extends in a direction generally away from the second end of the housing.

Preferably the gripping features comprise ridges projecting into the groove. In some embodiments the ridges may extend at an angle of approximately 45° to a longitudinal axis of the groove.

The ridges are preferably angled to pull a rope into the groove when the rope is pulled in a direction substantially towards the corresponding projection.

To improve the ease with which a rope may be wrapped around the descender device and engaged with the retaining means, the housing preferably further comprises an alignment groove between at least one of the ports and a corresponding one of the projections. The alignment groove is preferably in line with this port and is oriented to direct the rope from this port to the corresponding projection.

Preferably the descender device further comprises guide means positioned within the housing between the entry and exit ports and the drive pulley. The guide means may comprise a guide member and two guide posts, and, in use, a first portion of the rope extends from the entry port, between a first surface of the guide member and a first guide post, towards the drive pulley, and a second portion of the rope extends away from the drive pulley, between a second surface of the guide member and a second guide post, towards the exit port.

The centrifugal brake may comprise a sealed centrifugal brake in which the brake mechanism is contained within a sealed chamber or sealed brake housing.

The centrifugal brake may be contained within a sealed brake chamber.

Preferably a valve is provided on the sealed brake chamber or sealed brake housing.

The valve may comprise a one way valve.

The valve may enable moisture to escape from within the sealed brake chamber or sealed brake housing. The valve may prevent liquid and/or moisture from entering the sealed brake chamber or sealed brake housing.

The valve may comprise a Gore valve.

According to a second aspect of the present invention there is provided an assembly comprising a descender device according to the first aspect of the invention and a rope, a portion of the rope entering the housing through the entry port and exiting the housing through the exit port, and the portion of the rope within the housing being looped around the drive pulley.

Also according to the invention, there is provided a method of using an assembly comprising a descender device and a rope to control the ascent or descent of an object or person on a rope, the assembly being according to the second aspect of the invention, and the method comprising the steps of:
directing the rope extending from one of said ports to one of said side walls of said housing adjacent said port at the second end of said housing, and from the second end of said housing and along said side wall to a corresponding one of said projections on said side wall;
looping said rope around said projection and into a corresponding groove on said side wall; and
directing said looped rope back towards the second end of said housing and securely engaging said rope within said groove in order to control said ascent or descent.

When the assembly is used with the ports at a lower end of the housing, the user will direct the rope from the groove laterally across the second end of the housing, and from the second end of the housing upwards into a corresponding groove on the opposite side wall and to a corresponding one of the projections on the opposite side wall. The user can then loop the rope around the projection on the opposite side wall. The rope will then hang down under its own weight. This will then securely engage the rope within the groove on the opposite side wall.

When the assembly is used with the ports at an upper end of the housing, the user will direct the rope from the groove laterally across the second end of the housing, and from the second end of the housing downwards into a corresponding groove on the opposite side wall. The rope will then hang down under its own weight. This will then securely engage the rope within the groove on the opposite side wall.

### BRIEF DESCRIPTION OF THE DRAWINGS

The present invention will now be further described, by way of example only and with reference to the accompanying drawings, in which:

FIG. 1 is a perspective view from the front of a descender safety device according to a preferred embodiment of the present invention;

FIG. 2 is a perspective view from the rear of the descender safety device of FIG. 1;

FIG. 3 is a plan view from the front of the descender safety device of FIG. 1;

FIG. 4 is a plan view from the rear of the descender safety device of FIG. 1; FIG. 5 is a plan view from the right side of the descender safety device of FIG. 1;

FIG. 6 is an exploded view of the components of the descender safety device of FIG. 1;

FIG. 7 is a partial cross-sectional view of the descender safety device of FIG. 1 showing a rope secured to the device, and with parts partially cut away to show the internal arrangement of components;

FIG. 8 is a plan view from the front of another preferred embodiment of a descender safety device of the present invention;

FIG. 9 is a plan view from the right side of another preferred embodiment of a descender safety device of the present invention;

FIG. 10 is a cross-section through A-A of FIG. 8 of another preferred embodiment of a descender safety device of the present invention;

FIG. 11 is a plan view from the rear of another preferred embodiment of a descender safety device of the present invention;

FIG. 12 is a perspective view from the rear of another preferred embodiment of a descender safety device of the present invention;

FIG. 13 is a perspective view from the front of another preferred embodiment of a descender safety device of the present invention; and

FIG. 14 is an exploded view of the components of another preferred embodiment of a descender safety device of the present invention.

### DESCRIPTION OF THE PREFERRED EMBODIMENTS

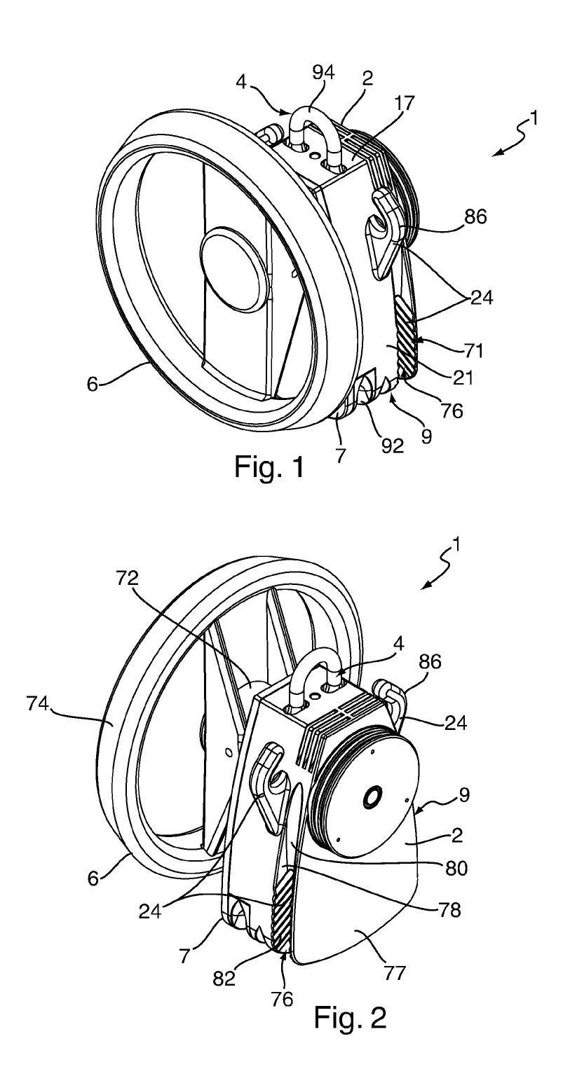

FIGS. 1 to 5 show external views of a descender 1 according to a preferred embodiment of the present invention. The device comprises a main body 2 having an attachment means 4 for connection to an anchor point or person and a wheel 6 that may be gripped and turned by a user of the descender 1.

The main body 2 has a hollow interior 3 that is closed by front face plate 7 that is removably attached to the main body. The main body 2 and front face plate 7, together with other parts to be described below, form a housing 9 for components held within the housing.

The main body 2 is a monobloc, that is, a unitary body formed as a single piece. In this example, the main body is formed as a cast aluminium body and the front face plate is an aluminium plate. Preferably, these components have anodised external surfaces. The cast monobloc will be machined where necessary.

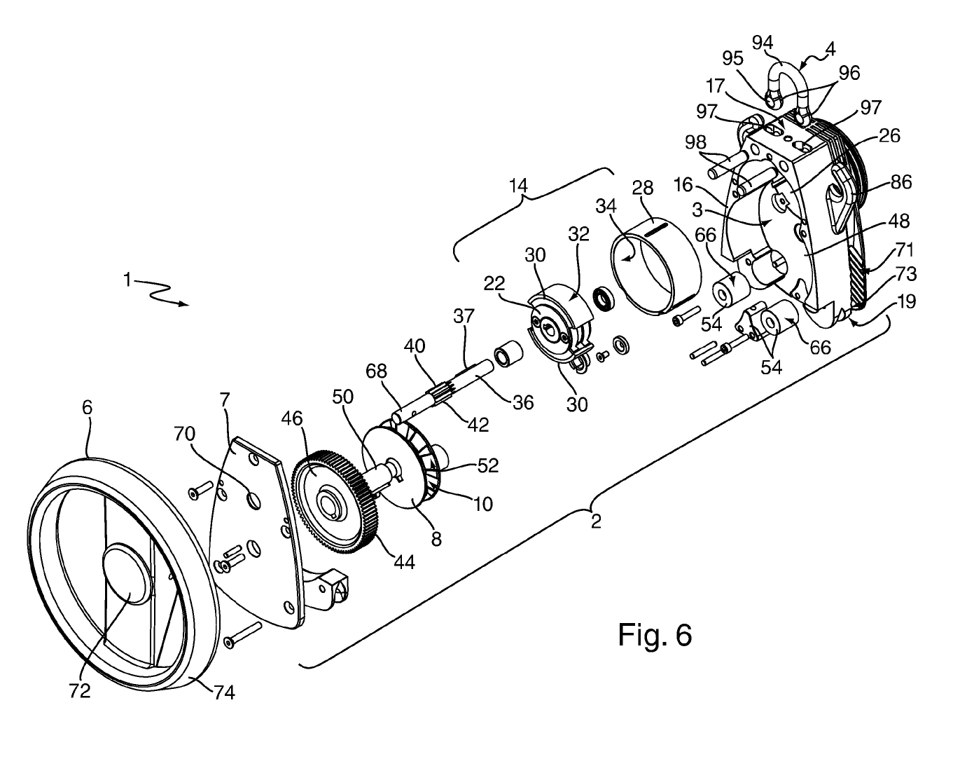

As shown in FIG. 6, within the housing 9 there is mounted a drive pulley 8 with a circumferential groove 10 for receiving a loop of rope 12. The drive pulley 8 is connected, via a suitable gear assembly to a centrifugal brake assembly 14. The wheel 6, which is located external to the housing 9, is spaced apart from and parallel with the front face plate 7, is also connected via the gear assembly to the drive pulley 8, enabling the drive pulley 8 to be rotated by rotating the wheel 6.

In use, a first end 18 of a length of rope 12 is attached to a person or object (not shown). The length of rope 12 extends into the housing 9, around the drive pulley 8 and back out of the housing 9. A second end 20 of the rope 12 is a free end of the rope. The rope 12 is free to move into and out from the housing 9 and around the drive pulley 8 in either direction, allowing a person or object to ascend or descend using the descender 1.

To descend, the free end 20 of the rope 12 is not fixed or held, and the weight of the person or object attached to the first end 18 of the rope 12 causes the rope to travel in a first direction through housing 9 of the descender 1. Movement in this direction causes the length of rope between the first end 18 of the rope 12 and the descender 1 to increase, thereby lowering the person or object away from the descender 1. As the speed of descent increases, the speed of rotation of the drive pulley 8 also increases. This, in turn, increases the speed of rotation of a hub 22 of the centrifugal brake assembly 14. At a particular speed of rotation the brake engages and acts to limit the speed of rotation of the hub 22 and, therefore, the speed of rotation of the drive pulley 8. The person or object then continues to descend at a fixed speed, determined by the centrifugal brake assembly 14.

To ascend, a user grips and turns the wheel 6 in a first direction. This causes the drive pulley 8 to rotate such that the rope 12 travels in a second, opposite direction through the housing 9 of the descender 1. Movement in this direction causes the length of rope between the first end 18 of the rope 12 and the descender 1 to decrease, thereby raising the person or object towards the descender 1.

It is also possible to use the descender 1 in an inverted configuration. This configuration is typically used if a person wishes to raise or lower themselves using the descender 1. In this configuration the person is attached to the attachment means 4 of the descender 1, and the first end 18 of the rope 12 is attached to an anchor point. As described above, to lower themselves relative to the anchor point, the user releases the free end 20 of the rope 12 and allows the rope to move through the housing 9 of the descender 1 in the first direction. To ascend, the user turns the wheel 6 as described above. It is also possible to turn the wheel to descend if it is desired to have more control over the speed of descent, or to descend only a short distance and then stop.

During use of the descender 1, and in particular during use of the descender to raise a person or object, it is desirable if the user is able to raise the person or object over a first distance and then pause or rest before raising the person or object through a second distance. Additionally it is desirable if ascending or descending can be halted such that the person or object is suspended at a required distance from the descender 1 or anchor point.

To enable this to happen, the descender 1 of the present invention comprises rope retaining means 24 on an outside of the housing 9, which in this example is provided by retaining features provided on an external surface of the main body 2. In use, the free end 20 of the rope 12 may be wrapped around the external surface of the housing 9 and engaged with the retaining means 24 to prevent the rope 12 moving through the main body 2 in either the first or second direction. The first end 18 of the rope 12 is, thereby, held at a fixed distance from the descender 1 or anchor point.

The specific features of a preferred embodiment of the descender 1 will now be described in more detail with reference to the accompanying drawings.

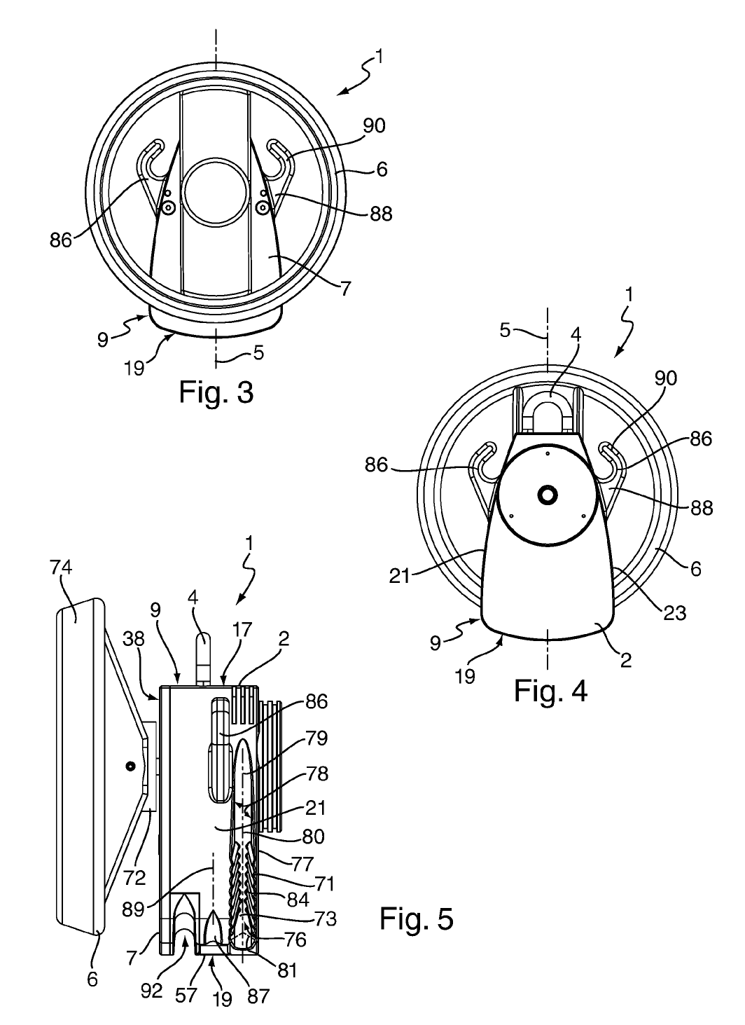

The housing 9 is substantially cuboidal, being elongate a with external surfaces having left-right symmetry as drawn in FIGS. 3 and 4 about a longitudinal axis or plane 5 bisecting the housing. The attached main body 2 and front face plate 7 provide a first, upper end 17 of the housing, and part of a second, lower end 19 of the housing. The attached main body 2 and front face plate 7 also provide two side walls 21, 23 of the housing extending between the upper and lower ends 17, 19 of the housing. It should be appreciated that the terms “upper” and “lower” relate to the orientation shown in the drawings, and as explained above, the orientation will be reversed when the descender 1 is used in an in an inverted configuration. The housing 9 may include a suitable valve to permit a flow of air through the housing 9 to reduce moisture within the housing 9.

The attachment means 4 comprises a U-shaped member 94 having a hole 95 proximate each of its two free ends 96. The free ends 96 are received in a pair of slots 97 in the upper end 17 of the housing. The free ends 96 of the U-shaped member 94 are secured in the housing 9 by means of a pair of pins 98 that engage with the holes 95 in the U-shaped member 92. In use, a hook or carabiner (not shown) is attached to the U-shaped member 94 and is used to secure the descender 1 to a person or object.

The centrifugal brake assembly 14 is mounted in an upper portion 26 of the housing 9 in the orientation illustrated in the drawings. The brake assembly 14 comprises an annular liner 28 made from a suitable metal such as cast iron or stainless steel. The hub 22 of the brake 14 is located within the liner 28 and is connected to two arcuate friction pads or shoes 30 by suitable biasing means. The biasing means, which will typically comprise tension springs, bias the shoes 30 radially inwards towards the hub 22. In use, as the rotation speed of the hub 22 increases the shoes 30 are forced radially outwards by the centrifugal force, against the tensile force of the springs, so that an outer surface 32 of each of the shoes 30 contacts an inner face 34 of the liner 28. The friction of the shoes 30 against the liner 28 dissipates energy such that the speed of rotation of the hub 22 is limited and, therefore, the speed of descent of the person or object is limited. This brake mechanism works equally well in either direction of rotation. Preferably the brake assembly 14 is configured such that the descent speed is limited to between 0.5 m/s and 2 m/s. The brake assembly may comprise a sealed brake unit.

The hub 22 of the brake assembly 14 is mounted on an elongate shaft 36 that extends through the hollow interior 3 of the main body 2 and protrudes from a front face 38 of the housing 9 provided by the front face plate 7. The shaft 36 is attached by means of a spline 37 to the hub 22 such that the hub 22 rotates together with the shaft 36. Approximately midway along the length of the shaft 36 is a region comprising radially extending teeth 40 forming a first, smaller diameter gear wheel 42.

The teeth 40 of the first gear wheel 42 engage and mesh with teeth 44 of a second, larger diameter gear wheel 46 that is mounted in a lower portion 48 of the housing 9. The first and second gear wheels 42, 46 together form the gear assembly of the descender 1. Because the first gear wheel 42 has a smaller diameter than the second gear wheel 46, the first gear wheel 42 rotates faster than the second gear wheel 46 in use. Additionally, the gear ratio is such that a smaller torque must be applied to the shaft 36 for a given, required output torque from the second gear wheel 46.

The second gear wheel 46 is mounted on a second shaft 50 within the housing 9, the second shaft 50 extending parallel to the first shaft 36. The drive pulley 8 is also attached to the second shaft 50 so that rotation of the second shaft 50 causes rotation of both the second gear wheel 46 and the drive pulley 8.

The drive pulley 8 comprises a circular disc or drum having the circumferential groove 10 extending around its edge for receiving a loop of the rope 12. Inner surfaces 52 of the groove 10 preferably have projecting portions to provide means for gripping the rope 12.

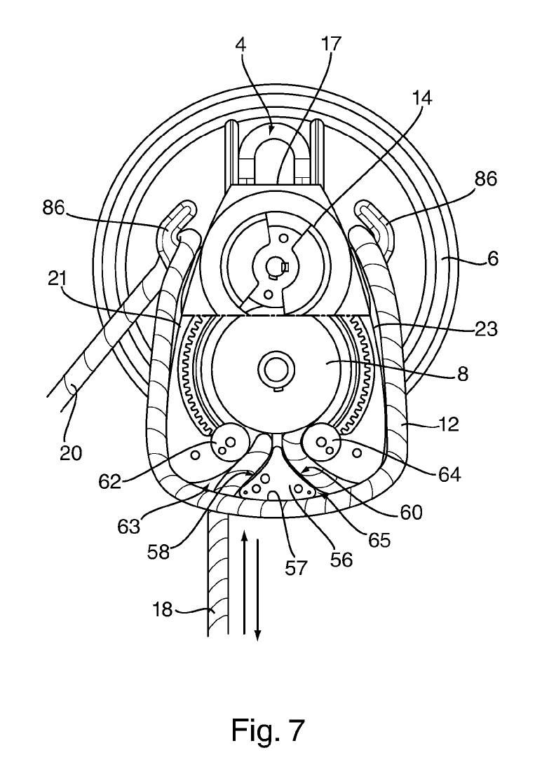

As shown most clearly in FIGS. 6 and 7, an arrangement of guide means or wear bearings 54 is located directly below the drive pulley 8 at the lower end 19 of the housing 9. The arrangement of guide means 54 comprises a central, substantially triangular guide member 56. A lower surface 57 of the guide member 56 extends to the lower end 19 of the housing 9 and two concave sides of the guide member form friction or wear surfaces 58, 60. Adjacent each of the wear surfaces 58, 60 is a substantially cylindrical guide post 62, 64, and at least a part of the surface of each post 62, 64 provides a further friction or wear surface 66. The distance between each of the guide posts 62, 64 and the adjacent wear surfaces 58, 60 of the guide member 56 is substantially equal to the thickness of the rope 12 to be used with the descender 1. Preferably the guide member 56 and posts 62, 64 are made from stainless steel.

A length of the rope 12 that is engaged with the descender 1 passes into and out from the housing 9 through a pair of adjacent ports 63, 65 in the lower end of the housing 9. Depending on the mode of operation, and on which end of the rope 12 is the free end, one of the ports will be an entry port for the rope 12, and the other of the ports will be an exit port for the rope. In the illustrated example, the entry port 63 is between a first one of the posts 62 and a first wear surface 58. Each port is nearest one of the side walls. The rope 12 loops around at least a part of the drive pulley 8 within the circumferential groove 10, passes between a second one of the posts 64 and a second wear surface 60, and exits the housing 9 through the exit port 65, as illustrated in FIG. 7.

The wheel 6 of the descender 1 is attached to an end 68 of the first shaft 36 that protrudes through an aperture 70 in the front face plate 7 of the housing 9. The wheel 6 has a central hub portion 72 which receives the end 68 of the shaft 36 and an annular gripping portion 74. The diameter of the gripping portion 74 is preferably substantially greater than the diameter of the drive pulley 8 and second gear wheel 46 to provide additional mechanical advantage.

In use, rotating the wheel 6 in a first direction causes the drive pulley to rotate in a second direction due to the arrangement of the gear assembly and shafts 36, 50. This rotation causes the first end 18 of the rope 12 to be drawn towards the housing 9 of the descender 1. Rotating the wheel in a second direction causes the drive pulley to rotate in a first direction, thereby permitting the distance between the first end 18 of the rope 12 and the housing to increase.

In order to prevent movement of the length of rope 12 through the descender 1 in either the first or second directions, to halt a descent or ascent, the free end 20 of the rope 12 may be engaged with the retaining means 24. The retaining means 24 comprises at least one groove or channel 76 provided in the outer surface of the housing 9 and at least one projection 86 provided on each side wall 21, 23 of the main body 2. The, or each, projection may be a hook or a cleat. Preferably, there is one projection on one or both side walls. In this example, there is one such hook 86 on each side wall 21, 23. In this example, there are two similar grooves 76, one for each side wall and projection. Each groove is in line with the other, such that the rope 12 when seated in one groove is aligned to enter the other. Preferably, the grooves are mirror images of each other about a vertically extending plane 5 through the housing. These grooves 76 are conveniently formed in the monobloc main body 2 of the housing.

The grooves 76 are located proximate a rear face 77 of the housing 9, as shown most clearly in FIGS. 2 and 5. Each groove 76 has a pair of opposite side walls 78 and a base 80, and the width of each groove 76, i.e. the distance between the side walls 78 is substantially equal to the diameter of the rope 12. To ensure the rope is seated securely when inserted the groove, it is preferred if the groove side walls 78 tapers slightly inwardly towards the base 80. The groove 76 extends across the corresponding side wall 21, 23 and wraps partly around the housing end portion 19. Each groove has a substantially straight gripping portion 71 that extends across one of the side walls 21, 23 and a curved end portion 73 that extends partly around the lower end 19 of the housing 9, ending short of the central plane 5 of the housing.

The two curved groove end portions 73 terminate with the groove axes in line with each other. As illustrated by the dashed line 81 in FIG. 5, instead of two grooves 76, it would alternatively be possible to have a single U-shaped groove by extending the curved groove end portions 73 to meet up with each other. However, in the preferred embodiment of the invention, each groove is provided primarily on one or the other of the first and second side walls 21, 23. In preferred embodiments, the groove 76 extends only part way up each of the side walls 21, 23 of the housing 9. As illustrated in FIG. 2, the groove 76 may extend up the side walls 21, 23 such that each end of the groove 76 is located between a corresponding one of the projections 86 and the rear face 77 of the housing 9.

The lateral distance between the axis 79 of each groove 76 and the corresponding projection 86 is such that the rope, when looped through 180° from an opposite side of the projection, is aligned to enter the groove. As can be seen from the side view of FIG. 5, the projection 86 lies between the groove axis and a port axis 89 from which the rope will extend. The rope 12 will therefore extend in opposite parallel directions on either side of the loop around the projection. This arrangement helps to ensure that the rope is easily routed around the projection and seated into the groove.

At least a part of the groove is provided with gripping features 82 in the form of a series of ridges 84 projecting inwardly from the side walls 78. The ridges 84 project into the groove 76 and, in use, grip the rope 12 when it is inserted into the groove 76. Preferably the ridges 84 are at an angle to a longitudinal axis 79 of the substantially straight gripping portion 71 of the groove 76. For example, as shown most clearly in FIGS. 2 and 5, the ridges 84 may extend at approximately 45° to the groove longitudinal axis 79. In the illustrated embodiment the ridges 84 are provided in the substantially straight section 71 of each groove 76 that extend along each of the side walls 21, 23 of the housing 9. Along each side wall 21, 23, the ridges extend, from the top of the groove at the side wall 21, 23 towards the base 80 of the groove, at an angle whereby the rope is directed by the ridges to seat deeper into the groove when the rope pulled along the groove axis 79 in a direction away from the lower end 19 of the housing 9 and towards the projection 86.

In this example, the projection is a single hook 86 provided on each side wall 21, 23 of the main body 2. Each of the hooks 86 includes a base portion 88 that is secured to the outer surface of the housing 9 and that extends away from the corresponding side wall 21, 23 and away from the lower end 19 of the housing 9, and an arm portion 90 that extends generally towards the corresponding side wall 21, 23 and towards the upper end 17 of the housing 9. Therefore, in this example, the projection 86 is curved generally upwards towards the upper end 17 of the housing 9, and in towards the central plane 5 of the housing as shown in FIGS. 3 and 4.

To secure or lock the length of rope 12 to the descender 1, the second end 20 of the rope 12, as it exits the main body 2 through the exit port 65, is curved around a lower corner of the housing 9 between the housing lower end and one side wall. Optionally, an alignment groove 87 may be provided around each of the lower corners of the housing 9 in line with the entry and exit ports 63, 65, to aid in the directing of the rope 12 from each port across each side wall 21, 23 towards the corresponding projection 86.

The length of rope 12 is then laid along one side wall 21 towards the upper end of the housing 9 and hooked or looped over a first one of the projections 86. By looping around each projection, the rope 12 is, thereby, redirected to extend back down towards the lower end 19 of the housing 9 in line with the groove 76. The rope 12 is then inserted into the groove 76 which then holds the rope. To hold the rope more securely, the rope may be curved around the lower end 19 of the housing 9 and inserted into the other groove 76 extending across the opposite side wall 23. The ridges 84 of each groove grip the rope 12 and retain it or lock it in position in each groove 76. After extending the rope 12 up the other side wall 23 of the housing 9, the rope is looped around the second one of the projections 86.

Wrapping the rope 12 in this way, and retaining it in position by means of the gripping features 82 in the grooves 76 and the projections 86, allows a user to release the second end 20 of the rope 12 without the rope being drawn through the descender 1. The user can then take a rest from operating the descender 1 or can work suspended by the descender 1 without needing to maintain a tensile force on the second end 20 of the rope 12. It is a particular advantage of the invention that the rope can be secured in this way easily by using just one hand as the rope is curved and wrapped around or into the engagement features on the external surface of the housing. The other hand is then free to grip the wheel 6 to hold the descender in place.

It will be appreciated that the rope 12 may be secured around the housing in a similar way when the descender 1 is being used in its inverted configuration. In this arrangement, the descender 1 is oriented such that the rope 12 exits the housing at a top of the device. The user can then draw the rope 12 down one of the side walls 21, loop it around the corresponding projection 86 and extend the rope 12 back upwards into the groove 76 one the same side wall. The user can then curve the rope laterally across the second end of the housing, which will be at the top of the device, and then back down into the second groove 76 on the other side wall. The rope will then be held or locked in position by means of the ridges 84. In this orientation there is no need to subsequently loop the rope 12 around the second one of the projections 86 on the second side wall 23, as the weight of the free end of rope will naturally keep the free end of the rope hanging in line with the second groove 76 in which the rope is engaged.

It should be noted that while use the grooves on both sides of the housing is highly desirable to fully lock the rope in place, the rope will be secured to some degree even by the first groove, which may be useful when the user needs to temporarily hold the rope in place.

In preferred embodiments the housing 9 comprises a second channel or slot 92 extending around the lower end 19 of the housing 9 proximate the front face 38 of the main body 2. This slot 92 is sized to receive the rope 12 and is used to provide guide means and additional friction means when the descender 1 is being used in an inverted configuration as described above.

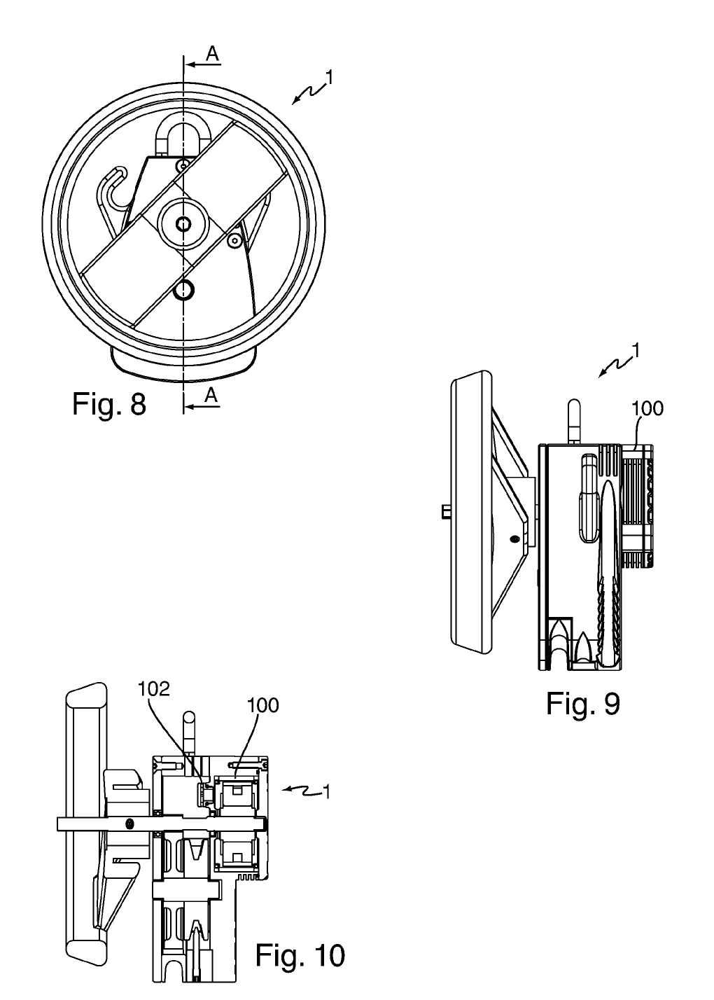

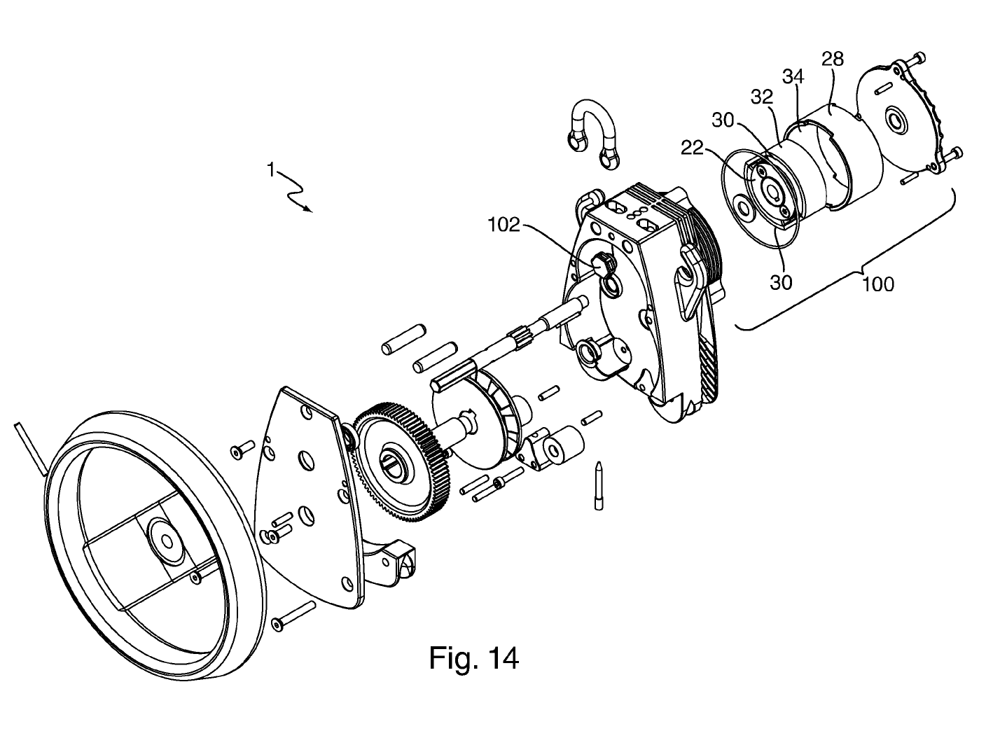

Another preferred embodiment of a descender 1 is shown in FIG. 8 to FIG. 14. This descender is primarily as described above. However, in this preferred embodiment the brake comprises a sealed brake unit 100. The sealed brake unit 100 provides a sealed self contained chamber in which the centrifugal brake is housed. The sealed chamber provides a protective environment for the centrifugal brake assembly. The sealed chamber is partitioned from the main compartment within the housing 9 which contains the gear mechanism and through which the rope passes.

The housing includes a valve 102 to permit a restricted flow of air from the sealed brake unit to the main compartment within the housing. This helps to protect the sealed brake unit 100. This valve 102 may comprise a gore/breathable valve which may regulate the moisture within the sealed brake unit 100.

Specifically, the valve 102 is arranged to regulate the moisture within the sealed brake chamber.

The valve 102 prevents the ingress or flow of liquids (moisture) into the sealed brake chamber. However, the valve 102 is a one way valve which enables moisture (or liquid) to flow out of the sealed chamber, for example, moisture may be allowed to escape from inside the sealed brake chamber.

Accordingly, the valve 102 protects the mechanism and integrity of the brake. The descender 1 may be used outdoors and may be used in rain/snow or in humid climates where water may usually penetrate into a brake chamber. However, the valve 102 prevents this from occurring in the present invention. Furthermore, if a descender 1 (or part thereof) is submerged (or otherwise has water/liquid within and/or around the brake mechanism) and the device is being used in low temperatures, then this liquid may freeze. Such frozen liquids (or even cold liquids) within a brake chamber can be catastrophic and may prevent the brake from operating at all or only operating to a lesser degree. Accordingly, the present invention overcomes this problem and similar associated problems.

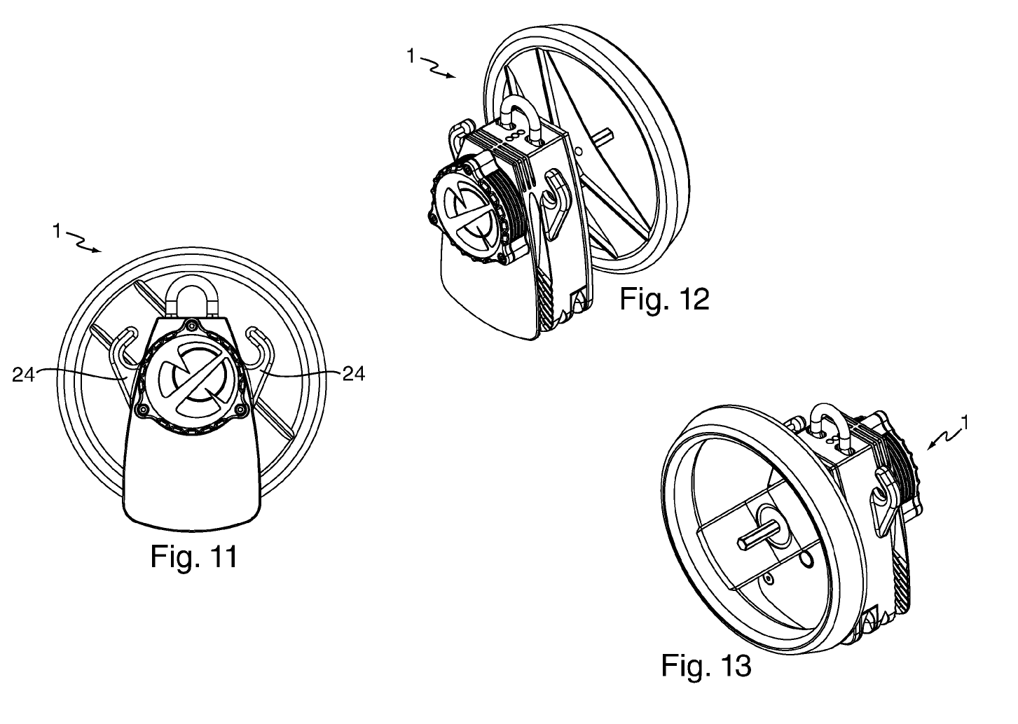

As shown in the Figures (and in particular FIG. 11), the descender 1 is ambidextrous and provides a rope friction point (rope retaining means 24) on both sides of the housing 9. Specifically, a projection 86 and associated groove 76 is provided for the left hand side and also for the right hand side. This enables a user to fix and secure the rope on selectively on either side of the housing 9.

The present invention, therefore, provides an improved descender device having means to retain and lock a portion of a rope to halt a descent, and method of using such a device to control the ascent or descent of an object or person on a rope.

1. A descender device for manually raising and lowering an object or person on a rope, the device comprising:
a housing having opposing first and second ends and opposing side walls extending between the first and second ends;
attachment means at the first end of the housing, the attachment means being configured for attachment to an anchor point or to said object or person to be raised or lowered;
a rope entry port and a rope exit port in the second end of the housing;
a drive pulley around which said rope may be engaged;
a centrifugal brake configured to limit the speed of rotation of the drive pulley;
a gear assembly connecting the drive pulley to the centrifugal brake;
a wheel arranged to be gripped by a user of the device, the wheel being connected to the gear assembly; and
rope retaining means provided on an outside of the housing, said retaining means comprising a projection on at least one of said side walls of the housing and at least one groove in an external surface of the housing, said groove extending across said side wall corresponding with said projection, said projection being configured to redirect said rope from one of said ports when said rope is looped around said projection so that said rope is aligned to enter said groove on said side wall, the groove including gripping features for gripping a portion of said rope inside said groove.

2. A descender device as claimed in claim 1 in which the drive pulley, centrifugal brake and gear assembly are mounted within the housing.

3. A descender device as claimed in claim 1, in which said groove extends around a corner between said side wall and the second end of the housing.

4. A descender device as claimed in claim 1, in which a projection is provided on both of said side walls, each of said projections being configured to redirect said rope from one of said ports when said rope is looped around said hook so that said rope is aligned to enter said groove.

5. A descender device as claimed in claim 4, in which there are two of said grooves, one for each of said projections on both of said side walls.

6. A descender device as claimed in claim 4, in which there is one groove which extends across both side walls and the second end of the housing.

7. A descender device as claimed in claim 1, in which the or each projection comprises an arm portion that extends in a direction generally away from the second end of the housing.

8. A descender device as claimed in claim 1, in which the gripping features comprise ridges projecting into said groove.

9. A descender device as claimed in claim 8, in which the ridges are angled to pull a rope into the groove when the rope is pulled in a direction substantially towards the corresponding projection.

10. A descender device as claimed in claim 1, in which the housing further comprises an alignment groove between at least one of said ports and a corresponding one of said projections, the alignment groove being in line with said port and being oriented to direct said rope from said port to said corresponding projection.

11. A descender as claimed in claim 1, in which the descender device further comprises guide means positioned within the housing between said entry and exit ports and the drive pulley.

12. A descender as claimed in claim 11, in which the guide means comprises a guide member and two guide posts, and wherein, in use, a first portion of said rope extends from said entry port, between a first surface of the guide member and a first guide post, towards the drive pulley, and a second portion of said rope extends away from the drive pulley, between a second surface of the guide member and a second guide post, towards said exit port.

13. A descender device as claimed in claim 1, in which said projection is a hook.

14. A descender device as claimed in claim 1 in which the centrifugal brake comprises a sealed centrifugal brake in which the brake mechanism is contained within a sealed chamber.

15. A descender device as claimed in claim 14 in which a valve is provided on the sealed chamber.

16. A descender device as claimed in claim 15 in which the valve comprises a one way valve which enables moisture to escape from within the sealed chamber and the valve prevents liquid and/or moisture from entering the sealed chamber.

17. An assembly comprising a descender device as claimed in claim 1 and a rope, a portion of the rope entering the housing through said entry port and exiting the housing through said exit port, and said portion of the rope within the housing being looped around the drive pulley.

18. A method of using an assembly comprising a descender device and a rope to control the ascent or descent of an object or person on a rope, the assembly being as claimed in claim 17, and the method comprising the steps of:
directing the rope extending from one of said ports to one of said side walls of said housing adjacent said port at the second end of said housing, and from the second end of said housing and along said side wall to a corresponding one of said projections on said side wall;
looping said rope around said projection and into a corresponding groove on said side wall; and
directing said looped rope back towards the second end of said housing and securely engaging said rope within said groove in order to control said ascent or descent.

19. A method as claimed in claim 18, when said assembly is used with said ports at a lower end of said housing, the method comprising additionally the steps of:
directing the rope from said groove across the second end of the housing, and from the second end of said housing into a corresponding groove on said opposite side wall and to a corresponding one of said projections on said opposite side wall; and
looping said rope around said projection on said opposite side wall to securely engage said rope within said groove on said opposite side wall.

20. A method as claimed in claim 18, when said assembly is used with said ports at an upper end of said housing, the method comprising additionally the steps of:
directing the rope from said groove across the second end of the housing, and from the second end of said housing into a corresponding groove on said opposite side wall to securely engage said rope within said groove on said opposite side wall.

21-24. (canceled)
